(19) United States
(12) Patent Application Publication
(10) Pub. No.: US 2003/0202504 A1
(43) Pub. Date: Oct. 30, 2003

(54) Method of implementing a VXML application into an IP device and an IP device having VXML capability

(75) Inventors: Krishna Dhara, Parlin, NY (US); David Skiba, Worthington, OH (US)

Correspondence Address: Edward M. Weisz, Esq., Cohen, Pontani, Lieberman & Pavane, Suite 1210, 551 Fifth Avenue, New York, NY, 10176, US

(73) Assignee: Avaya Technology Corp.

(21) Appl. No.: 10/135,120

(22) Filed: Apr. 30, 2002

(51) Int. Cl. H04L 12/66

(52) U.S. Cl. 370/352; 370/401; 379/900; 379/88.17

(57) ABSTRACT

A method of implementing a Voice Extensible Markup Language (VXML) application in an Internet Protocol (IP) device, and an IP device having VXML capability, are disclosed. An IP device having a VXML browser is provided. A VXML script file containing a plurality of instructions for a particular VXML application is fetched into the IP device from a server via an IP network to which the IP device is connected. The fetched VXML script file is then parsed into an appropriate format, and an VXML engine in the VXML browser executes the instructions of the parsed VXML script file to establish an audio interface with either the user of the IP device or a user of another IP device that is connected to the IP network.

### BACKGROUND OF THE INVENTION

1. Field of the Invention

The present invention is directed to internet protocol (IP) devices. More specifically, the present invention is directed to a method of implementing a voice extensible markup Language (VXML) application into an internet protocol device, and an IP device having VXML capability.

2. Description of the Related Art

Computer programmers have used extensible markup language (XML) to develop other customized markup languages generally known as XML applications. One such customized markup language is the voice extensible markup language (VXML or VoiceXML). With VXML, users can create and edit customized VXML applications to establish different audio dialogs for various other users so as to create an audio interface with those users.

One common VXML application is one that implements Interactive Voice Response (IVR) using a browser program that provides the capability to receive content in the form of audio, video or data. A remote server implementing IVR receives incoming calls and establishes a dialog with the respective callers. The server typically provides an initial predetermined voice message and may then may utilize other predetermined voice messages in response to a particular DTMF tone or audible reply from the caller.

Although VXML offers the flexibility to create and customize audio initiated dialogs, its implementation and use is currently limited to remote servers. As such, individual users of IP devices lack the flexibility to create their own VXML applications. With the continuing development of new features, there is both a desire and need to implement VXML applications in locally based IP devices.

### SUMMARY OF THE INVENTION

The present invention is directed to a method of implementing a voice extensible markup language (VXML) application into an internet protocol (IP) device, and to an IP device having VXML capability. Initially, an IP device having a VXML browser is provided. A VXML script file containing a plurality of instructions for a particular VXML application is fetched from a server via an IP network. The fetched VXML script file is next parsed into an appropriate format. A VXML engine in the VXML browser then executes the instructions of the VXML script file to establish an audio interface with either the user of the IP device or a user of another IP device that is connectable to or otherwise in communication with the IP network.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters delineate similar elements:

FIG. 1 is a block diagram of a computer system in one embodiment of the present invention;

FIG. 2 is a block diagram of a computer system in another embodiment of the invention;

FIG. 3 is a flowchart of a method of implementing voice extensible markup language (VXML) in accordance with the present invention;

FIG. 4 is a flowchart for processing a text prompt in a VMXL file;

FIG. 5 is a flowchart for processing an audio prompt in a VMXL file;

FIG. 6 is a flowchart for processing a user input provided in response to a prompt in a VXML file;

FIG. 7 is a flowchart implementing intelligent name dialing in a VXML application of the internet protocol (IP) device of the present invention;

FIG. 8 is a flowchart for downloading of ringing patterns in another VXML application of the IP device of the invention; and

FIG. 9 is a flowchart implementing interactive voice response (IVR) in yet another application of the IP device of the invention

### DETAILED DESCRIPTION OF THE PRESENTLY PREFERRED EMBODIMENTS

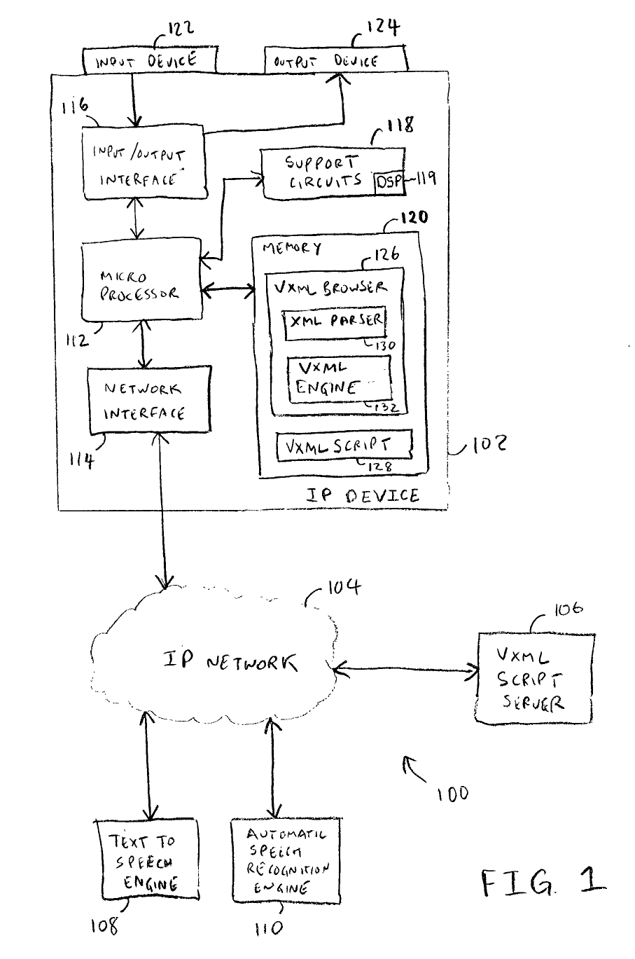

FIG. 1 depicts a computer network system 100 in a preferred embodiment of the present invention. The system or framework 100 comprises an internet protocol (IP) device 102, an IP network 104, a voice extensible markup language (VXML) file server 106, a text-to-speech (TTS) engine 108 and an automatic speech recognition (ASR) engine 110. IP device 102 is an communication device that is capable of transmitting and receiving voice via the IP network 104 in the form of data packets. Different types of IP devices include IP phones, desktop computers, personal digital assistant (PDA) devices, wireless communication devices, or any other computer-controlled devices having the capability of communicating voice signals over the IP network 104. Although one IP device 102 is shown, system 100 is applicable to a plurality of IP device 102 that communicates with or through IP network 104.

In the present invention, IP device 102 is capable of implementing a VXML application to provide an audio interface to a user of the device 102 and to users of other IP devices that communicate with or through IP network 104. Thus, one way in which the present invention differs from the prior art is that VMXL capability is extended beyond the remote servers and implemented within the locally-based IP device 102. Users of the IP device 102 with VXML capability are accordingly now provided, in accordance with the invention, with the flexibility to customize their own VXML applications and corresponding audio interfaces instead of simply using an available predetermined audio interface accessible from a remote server.

IP device 102 preferably comprises a microprocessor 112, a network interface 114, an input/output (I/O) interface 116, support circuits 118 and a memory 120. The microprocessor 112 executes instructions in software programs that are stored in the memory 120 so as to coordinate operation of the IP device. The network interface 114 allows the IP device 102 to communicate with various other IP devices connected to IP network 104, as for example the VXML file server 106, TTS engine 108 and ASR engine 110. One typical example of a network interface 112 is a conventional network interface card or network adapter card, although other forms of the interface 112, such as modems, are contemplated and known and may be employed.

I/O interface 116 allows the IP device 102 to receive from an input device 122 and transmit to an output device 124 various forms of data, audio and video. Examples of such input devices 122 include a microphone, keyboard, mouse and other hardware and software-implemented switches or actuators. Examples of output devices 124 include a speaker and a screen-type display. The support circuits 118 enable and enhance operation of the IP device 102 and may include a power supply, a DSP119, a clock and the like.

The memory 120 stores software and data structures that are required to operate IP device 102. Memory 120 preferably stores a VXML browser 126, one or more VXML files 128, an operating system and other software applications (not shown). VXML browser 126 contains instructions to implement an audio interface accessible to a user of the IP device 102 as well as users of remotely-connected IP devices, and preferably includes an extensible markup language (XML) parser 130 and a VXML engine 132. XML parser 130 parses XML-type files, including VXML files. VMXL engine 132 comprises a variety of software programs to coordinate and operate VXML browser 126. The VXML files 128 comprise files written in VXML language and typically include VXML script files and/or VXML batch files containing instructions for implementing an audio interface.

VXML file server 106 transmits predefined VXML script files to IP devices 102 that are connected to IP network 104. VMXL server 106 may transmit the VXML script files in response to a request signal from IP device 102 or, alternatively, independent of any such request signal. Although one VXML file server is depicted in FIG. 1, the system 100 may include a plurality of different VXML file servers operable for transmitting VXML script files for a variety of VXML applications.

TTS engine 108 is a specialized computer server that converts text into synthesized speech for IP device 102 and other IP devices connected to the IP network 104. The TTS engine receives the text via the IP network 104 from the IP device 102, synthesizes speech from the received text and transmits the synthesized speech via the network back to the IP phone.

The ASR engine 110 is a specialized computer server that performs speech recognition for IP device 102 and other IP devices that are connected to IP network 104. ASR engine 110 performs speech recognition in any known manner to determine whether speech or keyed input from an IP device 102 is recognizable. Once ASR engine 110 makes this determination, it performs the conversion and transmits the result via IP network 104 back to IP device 102.

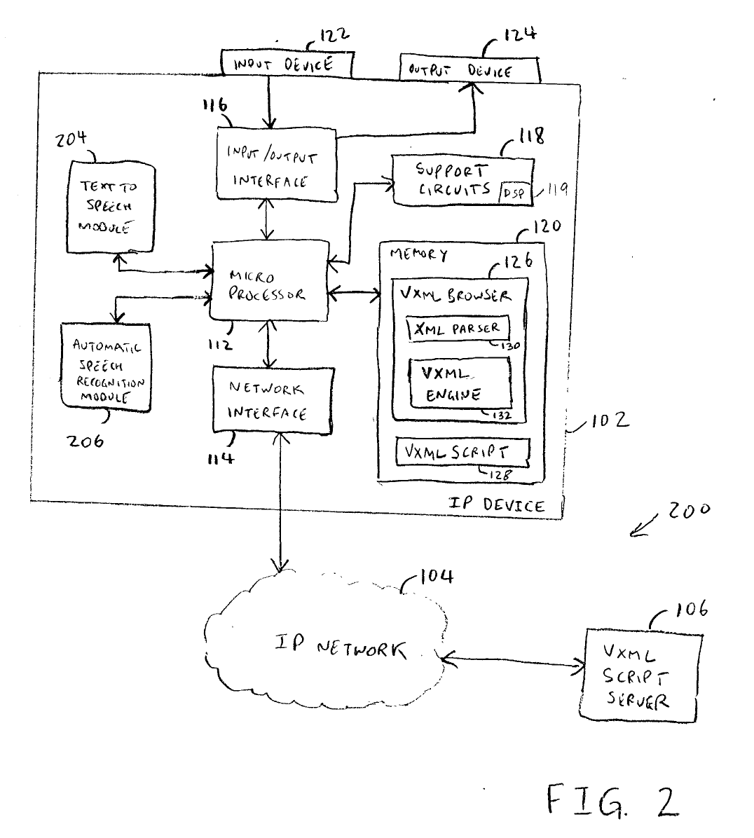

The implementation of high-quality text-to-speech conversion and speech recognition generally utilizes complex algorithms and requires powerful processors having significant processing power. For the system of FIG. 1, TTS engine 108 and ASR engine 110 are capable of respectively processing text-to-speech conversion and speech recognition for a plurality of IP devices 102 that are connected to IP network 104. However, to manage and accommodate large amounts of data, voice, video and the like concurrently transmitted over IP network 104, text-to-speech conversion and speech recognition may also be implemented within the local IP device 102. A block diagram of this further embodiment of a computer system 200 is shown in FIG. 2.

The system 200 of FIG. 2 is generally the same as the system 100 of FIG. 1, except that text-to-speech conversion and automatic speech recognition are implemented within the IP device 202. Specifically, IP phone 202 includes all of the components of IP device 102 of FIG. 1 plus a text-to-speech (TTS) module 204 and an automatic speech recognition (ASR) module 206. TTS module 204 is a processor-based module or application specific integrated circuit (ASIC) chip that performs the conversion of text to speech. ASR module 206 is a processor-based module or ASIC chip that carries out the recognition of speech and/or keyed-in (i.e. non-audio) input signals. Although shown as separate modules, TTS module 204 and ASR module 206 may also be implemented as software programs stored in memory 126 and executed by microprocessor 112.

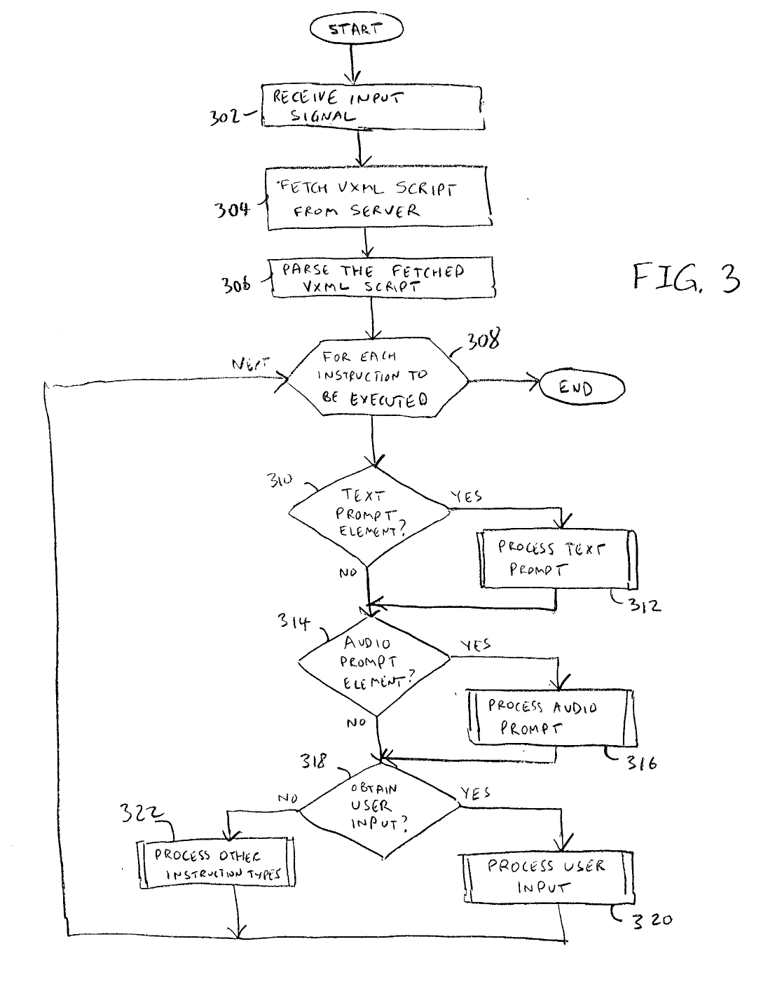

The flowchart of FIG. 3 depicts a method for implementing a VXML application in the IP device 102 and other IP devices in accordance with the present invention. The steps of this method are described below in the context of the IP device 102 implementing a single VXML application and are repeated each time the same or another VXML application is to be implemented from the device 102. In accordance with the present invention, IP device 102 is preloaded with a VXML browser 126 operable for coordinating the steps required to locally implement the stored VXML application.

VXML browser 126 is first initialized to form or define an audio interface for IP device 102. The VXML browser then passively awaits an input signal for a corresponding VXML application (step 302). Depending on the particular application, that input signal may for example comprise an outside call or an audio command from a user. In response to the input signal, VXML engine 132 of VXML browser 126 transmits a request for and fetches via network 104 a corresponding VXML script file from VXML server 106 (step 304). Although the VXML script file is illustratively pulled from VXML server 106 in response to the request, the script file may alternatively be pushed from VXML server 106 to IP device 102 without awaiting or requiring such a request.

XML parser 130 parses the fetched VXML script file 128 (step 306). VXML engine 132 then interprets and executes each instruction in the parsed script file (step 308) so as to establish a dialogue between IP device 102 and, for example, an incoming caller. Thus, the engine 132 may play a prerecorded or synthesized audio signal and receive from the user a voice or keyed-in input response. The exact combination of output audio signals and input voice or keyed signals will generally depend on the particular VXML application and the responses from the user or incoming caller or the like.

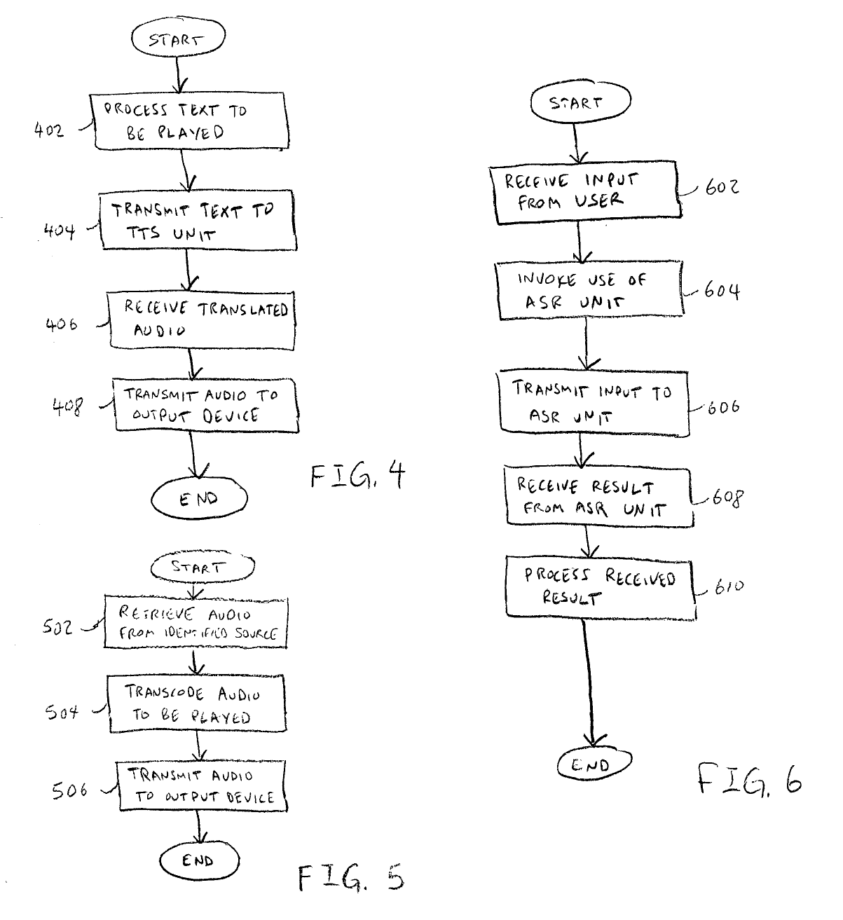

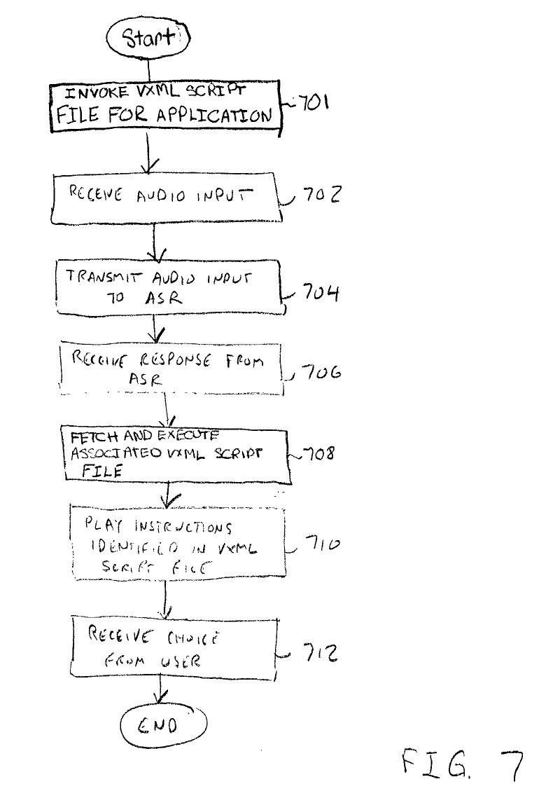

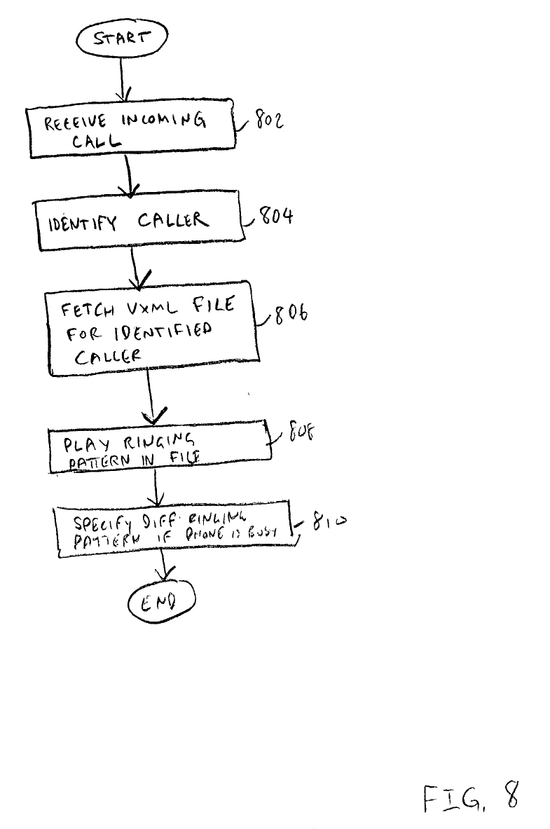

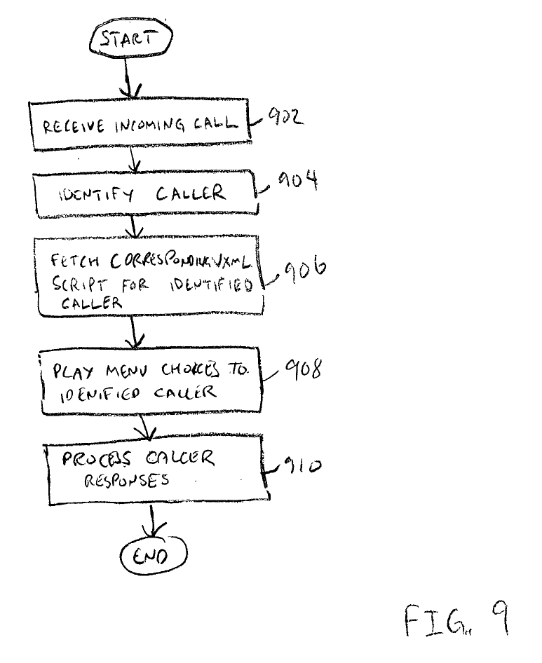

In the course of interpreting and executing the parsed instructions, VXML engine 132 next proceeds to identify specific instruction types and to process the identified instructions. For example, VXML engine 132 determines whether an instruction contains a text prompt element (step 310). A flowchart for processing text prompts in a VMXL document is shown in FIG. 4, in which, initially, VXML engine 132 processes the text message in the instruction to be played (step 402). That text is then transmitted via IP network 104 to TTS engine 108 (step 404), where the text is converted into speech and transmitted via the IP network back to IP device 102. Upon receipt of the translated speech (step 406), VXML engine 132 transmits the speech to the appropriate output device 124, as for example a speaker of IP device 102 (step 408).

Returning now to FIG. 3, VXML engine 132 also determines whether an instruction in the parsed VXML document 128 contains an audio prompt element (step 314). A flowchart for processing audio prompts in the VXML document 128 is depicted in FIG. 5. Thus, when VXML engine 132 processes the audio message in the instruction to be played (step 316), it (with reference to FIG. 5) retrieves the audio message from a source identified in the instruction (step 502) and transcodes the retrieved audio message to be played (step 504). That retrieved audio is then transmitted to output device 124 (step 506).

As further seen in FIG. 3, VXML engine 132 also identifies whether an instruction requires that a user input be obtained (step 318). A flowchart for obtaining and processing user input is shown in FIG. 6, in which VXML engine 132 first receives user input in the form of speech or keyed-in data, as for example DTMF (Dual Tone Multi-Frequency) signals (step 602). Once the input is received, VXML engine 132 invokes use of a predetermined remote ASR engine 110 or local ASR module 206 (step 604), transmits the received input via IP network 104 to the engine or module (step 606), and receives therefrom verification of the user input via the IP network (step 608). The VXML engine 132 then processes the received result (step 610), which may include the fetching and interpreting of additional VXML script files.

Returning once again to FIG. 3, VXML engine 132 also processes other types of instructions (step 322). The queries in steps 310, 312 and 314 are repeated for each instruction in the script file. Additional queries may also be required, depending on the nature of the dialog between the incoming caller and the IP device 102.

The local implementation of VXML in IP device 102 allows users of these devices to customize their own VXML applications in a manner similar to that used with XML. In accordance with the invention, users of IP device 102 can thus deploy or implement existing services in new ways and additionally deploy totally new services. Illustrative examples of such implementations are described below.

One possible VXML application, as depicted in the flowchart of FIG. 7, is the deployment of customized intelligent name dialing with IP device 102. At the start of this application the VXML script file is fetched and loaded (step 701), VXML engine 132 receives the name of the callee or person to be called in the form of speech input (step 702). VXML engine 132 then transmits the received input speech to the ASR engine 110 or ASR module 206 (step 704), and receives a response as to whether the speech has been verified (step 706). If the speech is not verified, then VXML engine 132 may provide another opportunity for the user to correctly speak the name of the callee. After successful verification, the VXML script logic associated with the caller name will be fetched and executed (step 708). For example, the user may have specified in the VXML script file various different work, home and cellphone numbers to reach that callee.

VXML engine 132 then plays or executes the script-specified prompts as to how the caller wishes to reach the callee as identified in the file (step 710). The user input response to those prompts in the form of voice commands or DTMF key inputs is then received and processed (step 712).

Another illustrative VXML-based application downloads particular ringing patterns, as shown in the flowchart of FIG. 8. An incoming call is received (step 802) and VXML engine 132 uses an ASR engine 110 or ASR module 206 to identify the caller (step 804). Engine 132 then fetches a VXML script file 128 previously stored in memory 120 (step 806) and plays a particular ringing pattern associated with the identified user (step 808). Where the file 128 contains a link to an audio file, VXML engine 132 retrieves and plays that audio file. If the file 128 alternatively or additionally includes a text message, then VXML engine 132 will also require the use of TTS engine 108 or TTS module 204 to convert the text to speech before playing the synthesized speech message. Because VMXL browser is located in the IP device 102, VMXL engine 132 can determine the status of device 102 and specify a different ringing pattern if device 102 is busy or otherwise in use (step 810).

Yet another illustrative VXML-based application can provide a user-customized IVR (Interactive Voice Response) for specific identified callers. A user can readily specify the dialogue in the IVR by modifying an existing VXML file to customize the IVR dialogue or can obtain a prepared VXML file from a VXML server that is operable to generate VMXL scripts based on an identified caller.

In the use of this VXML IVR application, which is shown in the flowchart of FIG. 9, a call is initially received at IP device 102 (step 902). The caller is identified using an ASR engine 110 or ASR module 206, as for example by a conventional caller identifier device (step 904). VXML engine 132 fetches a corresponding VXML script file 128, preferably from memory 120, for the identified caller (step 906). VXML engine 132 then executes the fetched script to play the programmed as menu choices that are indicated as available to the identified caller. Since the menu choices are typically text stored within the file 128, playing of these choices requires the use of TTS engine 110 or TTS module 204 to convert the stored text into synthesized speech. A response from the caller is then received and processed in VXML engine 132. The playing of additional menu choices and processing of any resulting additional caller responses are performed as required.

The illustrative VXML applications described above in the flowcharts of FIGS. 7 to 9 are of course merely examples of numerous possible VXML applications and are therefore not intended to be limiting as to the scope of the present invention. Thus, other VXML applications may for example enable users of IP device 102 to surf the internet and/or access remote databases using audio commands and/or create applications using local device resources.

Accordingly, while there have shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We I claim:

1. A method for implementing a voice extensible mark up language (VXML) application in an internet protocol (IP) device, the method comprising the steps of:
providing a VXML browser in the IP device;
fetching from a server, via an IP network with which the IP device is in communication, a VXML script file containing a plurality of instructions for the VXML application;
parsing the fetched VMXL script file; and
executing at least some of the plurality of instructions in the parsed VXML script file to establish an audio interface with one of a user of the IP device and a user of another IP device that is connectable to the IP network.

2. The method of claim 1, wherein said step of executing further comprises playing an audio data associated with the fetched VXML script file.

3. The method of claim 2, wherein the played audio data comprises a request for user input as one of a menu selection and a form input.

4. The method of claim 1, wherein said step of executing comprises the steps of:
extracting a text message from the parsed VXML script file; and
converting, via a text to speech (TTS) engine, the extracted text message into audio data defining speech corresponding to the text message.

5. The method of claim 4, wherein the played audio data comprises a request for user input as one of a menu selection and a form input.

6. The method of claim 1, wherein said step of executing further comprises receiving an input signal associated with one of said IP device and another IP device in communication with the IP network.

7. The method of claim 6, further comprising the step of verifying, via a speech recognition engine, the received input signal.

8. The method of claim 7, wherein said step of verifying comprises identifying a user of the another IP device.

9. The method of claim 6, wherein the input signal comprises at least one of a spoken input and a keyed input.

10. The method of claim 1, further comprising the step of editing the fetched VXML script file to customize the VXML application for a user of one of said IP device and another IP device that is connectable to the IP network.

11. The method of claim 10, further comprising the steps of:
receiving an input command associated with the user of the another IP device that is connectable to the IP network;
identifying the user of the another IP device;
retrieving the edited VXML script file; and
executing instructions in the retrieved VXML script file to establish the audio interface with the user of the another IP device.

12. The method of claim 1, wherein the IP device is an IP telephone.

13. The method of claim 1, wherein the IP device is a personal digital assistant (PDA) device.

14. The method of claim 1, wherein the IP device is a computer terminal.

15. An internet protocol (IP) device having voice extensible mark up language (VXML) capability, comprising:
a network interface coupled to an IP network for communicating between the IP device and the IP network;
a memory storing a VXML browser and a VXML script file, wherein the VXML browser comprises a VXML engine, and wherein the VXML script file is initially fetched from a server coupled to the IP network and contains a plurality of instructions directed to a VXML application; and
a microprocessor coupled to said memory and to said network interface for executing the VXML engine and the plurality of instructions in the VXML script file to establish an audio interface with one of a user of the IP device and a user of another IP device that is connectable to the IP network.

16. The IP device of claim 15, further comprising a speaker to output a played audio file associated with the VXML application.

17. The IP device of claim 16, wherein said VXML engine is operable to direct a conversion, via a text-to-speech (TTS) server coupled to the IP network, of a text message into an audio file defining speech corresponding to the text message.

18. The IP device of claim 15, further comprising an input means for receiving an input signal associated with another IP device connected to the IP network.

19. The IP device of claim 18, wherein said VXML engine is operable to direct verification, via an automatic speech recognition engine coupled to the IP network, of the received input signal.

20. The IP device of claim 15, further comprising:
a text-to-speech module coupled to said microprocessor for converting a text message in the VXML script file into an audio file defining speech corresponding to the text message; and
an automatic speech recognition module coupled to said microprocessor for verifying an input signal associated with a user of another IP device connected to the IP network.

21. The IP device of claim 15, wherein said IP device is an IP telephone.

22. The IP device of claim 15, wherein the IP device is a personal digital assistant (PDA) device.

23. The IP device of claim 15, wherein the IP device is a computer terminal.

24. A method for operating an internet protocol (IP) device of a local user to establish a communication session through an IP network between the IP device of the local user and an IP device of a remote user connected to the IP network, the method comprising the steps of:
providing a VXML browser in the IP device of the local user; accessing from a server through the IP network a VXML script file containing a plurality of instructions for the VXML application;
parsing the accessed VMXL script file in the IP device of the local user;
executing at least some of a plurality of instructions in the parsed VXML script file to establish for the IP device of the local user an audio interface;
receiving a command from one of the IP device of the remote user and the IP device of the local user for requesting a connection between the remote and local user devices;
verifying, via a speech recognition engine, whether the received command is valid; and
if the received command is valid, establishing the communication session via the IP network between the local user and the remote user.

25. The method of step 24, further comprising the step of providing a reply to the IP device that transmitted the connection request.

26. The method of claim 25, wherein the reply comprises a request for additional input as one of a menu selection and a form input.

27. The method of step 24, wherein said executing step further comprises the step of playing audio data on said on of said local user device and remote user device in accordance with the fetched VXML script file.

28. The method of claim 24, wherein the input signal comprises at least one of a spoken input and a keyed input.

29. The method of claim 24, further comprising the step of editing the fetched VXML script file to customize the VXML application in the IP device of the local user for one of the IP device of the local user and the IP device of the remote user connected to the IP network.
